(19) United States
(12) Patent Application Publication
(10) Pub. No.: US 2026/0142908 A1
(43) Pub. Date: May 21, 2026

(54) ERROR HANDLING AND CONTINUITY DETECTING FOR A BORDER GATEWAY PROTOCOL MULTIPLE NEXT HOP ATTRIBUTE

(71) Applicant: Juniper Networks, Inc., Sunnyvale, CA (US)

(72) Inventor: Kaliraj VAIRAVAKKALAI, Mountain House, CA (US)

(21) Appl. No.: 19/385,520

(22) Filed: Nov. 11, 2025

Related U.S. Application Data
(60) Provisional application No. 63/722,252, filed on Nov. 19, 2024.

(51) Int. Cl. H04L 45/02

(52) U.S. Cl. CPC H04L 45/02

(57) ABSTRACT

A network device may receive, from a source, a route for a destination, and may provide hierarchical error handling functionality in a border gateway protocol (BGP) MultiNexthop (MNH) attribute associated with the route. The network device may provide continuity detection functionality in the BGP MNH attribute, and may forward the route to the destination based on the hierarchical error handling functionality, the continuity detection functionality, and the BGP MNH attribute.

### CROSS-REFERENCE TO RELATED APPLICATION

This Patent Application claims priority to U.S. Provisional Patent Application No. 63/722,252, filed on Nov. 19, 2024, and entitled “ERROR HANDLING AND CONTINUITY DETECTING FOR A BORDER GATEWAY PROTOCOL MULTIPLE NEXT HOP ATTRIBUTE.” The disclosure of the prior Application is considered part of and is incorporated by reference into this Patent Application.

### BACKGROUND

The border gateway protocol (BGP) includes a set of rules that allows networks to communicate with each other by exchanging routing information and determining a best path for data to travel.

### SUMMARY

Some implementations described herein relate to a method. The method may include receiving, from a source, a route for a destination, and providing hierarchical error handling functionality in a BGP MultiNexthop (MNH) attribute associated with the route. The method may include providing continuity detection functionality in the BGP MNH attribute, and forwarding the route to the destination based on the hierarchical error handling functionality, the continuity detection functionality, and the BGP MNH attribute.

Some implementations described herein relate to a network device. The network device may include one or more memories and one or more processors. The one or more processors may be configured to receive, from a source, a route for a destination, and provide hierarchical error handling functionality in a BGP MNH attribute associated with the route, wherein the BGP MNH attribute includes an MNH header and an MNH type-length-value. The one or more processors may be configured to provide continuity detection functionality in the BGP MNH attribute, and forward the route to the destination based on the hierarchical error handling functionality, the continuity detection functionality, and the BGP MNH attribute.

Some implementations described herein relate to a non-transitory computer-readable medium that stores a set of instructions. The set of instructions, when executed by one or more processors of a network device, may cause the network device to receive, from a source, a route for a destination, wherein the source is one of an endpoint device or a server device. The set of instructions, when executed by one or more processors of the network device, may cause the network device to provide hierarchical error handling functionality in a BGP MNH attribute associated with the route, and provide continuity detection functionality in the BGP MNH attribute. The set of instructions, when executed by one or more processors of the network device, may cause the network device to forward the route to the destination based on the hierarchical error handling functionality, the continuity detection functionality, and the BGP MNH attribute.

### BRIEF DESCRIPTION OF THE DRAWINGS

FIGS. 1A-1I are diagrams of an example associated with error handling and continuity detecting for a BGP multiple next hop attribute.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for error handling and continuity detecting for a BGP multiple next hop attribute.

### DETAILED DESCRIPTION

The following detailed description of example implementations refers to the accompanying drawings. The same reference numbers in different drawings may identify the same or similar elements.

A next hop is an instruction on how to forward traffic to entities specified in BGP network layer reachability information (NLRI). The instruction includes an endpoint identifier (e.g., where to forward the traffic), an encapsulation to use (e.g., a label stack, a security identifier (SID), and/or the like), constraints (e.g., a proximity check and a color of path to use), and endpoint properties (e.g., a bandwidth and accumulated interior gateway protocol (AIGP)). The endpoint identifier may include a next hop attribute, a network address of a next hop, a redirect to an Internet protocol (IP) extended community attribute, a tunnel encapsulation attribute, a color-only extended community attribute, a redirect to virtual routing and forwarding (VRF) extended community attribute, a next hop dependent capability (NHC) attribute, and/or the like. The constraints may include a proximity check (e.g., a single hop or a multiple hop configuration), a color community or a mapping community attribute, an encapsulation to use, a reach NLRI attribute, a prefix SID attribute, a tunnel encapsulation attribute, a repair label attribute, a secondary label attribute, a redirect to actions, entropy label capability (ELC) attributes, an NHC attribute, and/or the like. The endpoint properties may include a link bandwidth extended community attribute, an AIGP attribute, an NHC attribute, and/or the like.

Current techniques for expressing next hops in BGP have several issues. For example, forwarding information is not scoped in one place, and there is an inability of a network device to advertise more than one next hop in a route. Furthermore, expressing next hops in BGP is not easily extensible to newer endpoint types and/or encapsulation types. When adding a path, a network device is unable to express a relationship between different next hops (e.g., active or backup). A network device is unable to signal encapsulation information uniformly across families (e.g., cannot signal labels for a flow specification route), and is unable to signal an additional label stack for a repair path in a route (e.g., which may be helpful in some multihomed cases to avoid label oscillation or a forwarding loop). Thus, current techniques for expressing next hops in BGP consume computing resources (e.g., processing resources, memory resources, communication resources, and/or the like), networking resources, and/or the like, associated with failing to advertise more than one next hop in a route, failing to extend expressing next hops to newer endpoint types and/or encapsulation types, failing to express a relationship between different next hops, failing to signal encapsulation information uniformly across families, failing to signal an additional label stack for a repair path in a route, and/or the like.

Some new procedures described herein relate to a network device that provides error handling and continuity detecting for a BGP MultiNexthop (MNH) attribute. For example, the network device may receive, from a source, a route for a destination, and may provide hierarchical error handling functionality in a border gateway protocol (BGP) MultiNexthop (MNH) attribute associated with the route. The network device may provide continuity detection functionality in the BGP MNH attribute, and may forward the route to the destination based on the hierarchical error handling functionality, the continuity detection functionality, and the BGP MNH attribute.

In this way, the network device provides error handling and continuity detecting for a BGP MultiNexthop attribute. For example, the network device may enhance a BGP MultiNexthop (e.g., multiple next hop or MNH) attribute by providing hierarchical error handling in the BGP MNH attribute. The network device may provide a new bit (e.g., an “M” bit) in MNH Type-Length-Value (TLV) flags of the BGP MNH attribute. If the bit is zero, the network device may ignore any error. If the bit is one, the network device may percolate any error to an upper layer TLV, until the error reaches the MNH attribute. The network device may also provide continuity detection in the BGP MNH attribute. The network device may provide two new bits (e.g., a “C” bit and an “E” bit) to enable continuity detection in the BGP MNH attribute. For example, some forwarding arguments carried in the MNH attribute may need to accumulate a value across BGP next hop self hops, and the network device may need to determine whether a forwarding argument signifies continuity until egress network devices are reached. Thus, the network device conserves computing resources, networking resources, and/or the like that would otherwise have been consumed by failing to advertise more than one next hop in a route, failing to extend expressing next hops to newer endpoint types and/or encapsulation types, failing to express a relationship between different next hops, failing to signal encapsulation information uniformly across families, failing to signal an additional label stack for a repair path in a route, and/or the like.

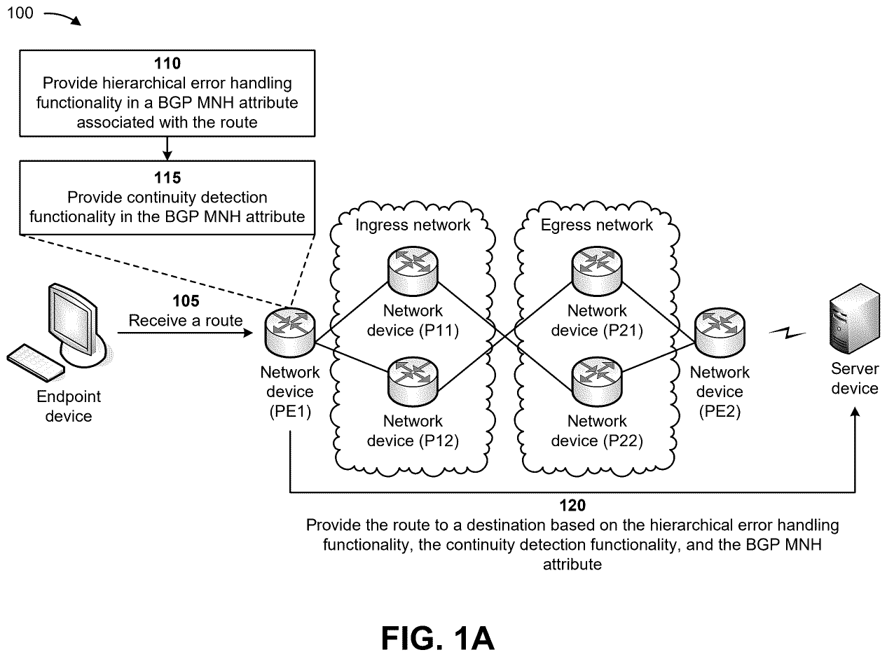

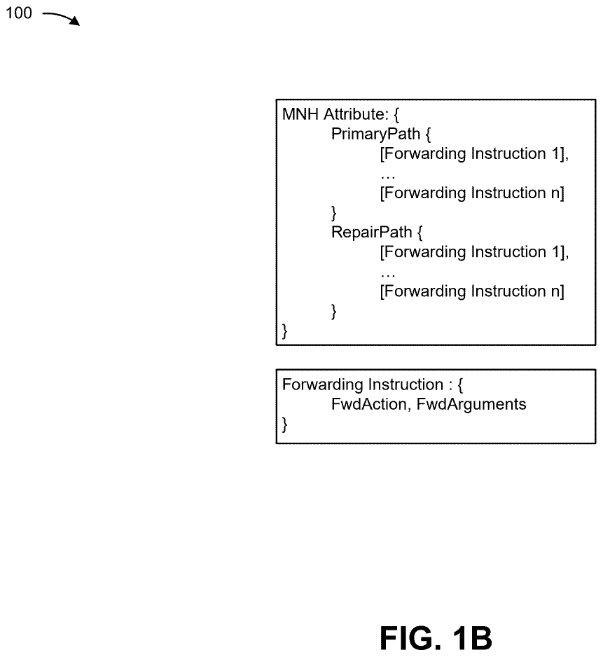

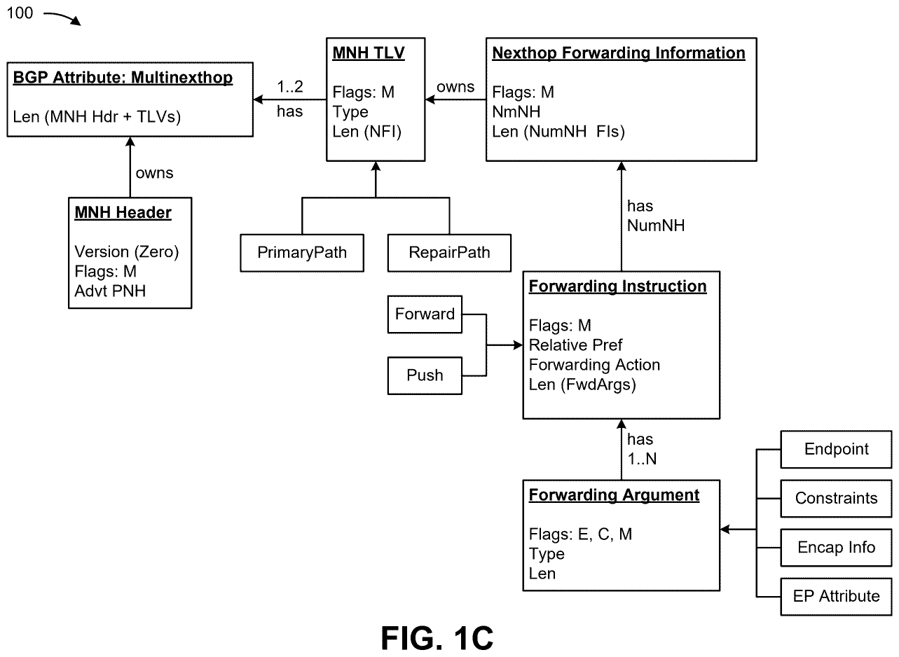

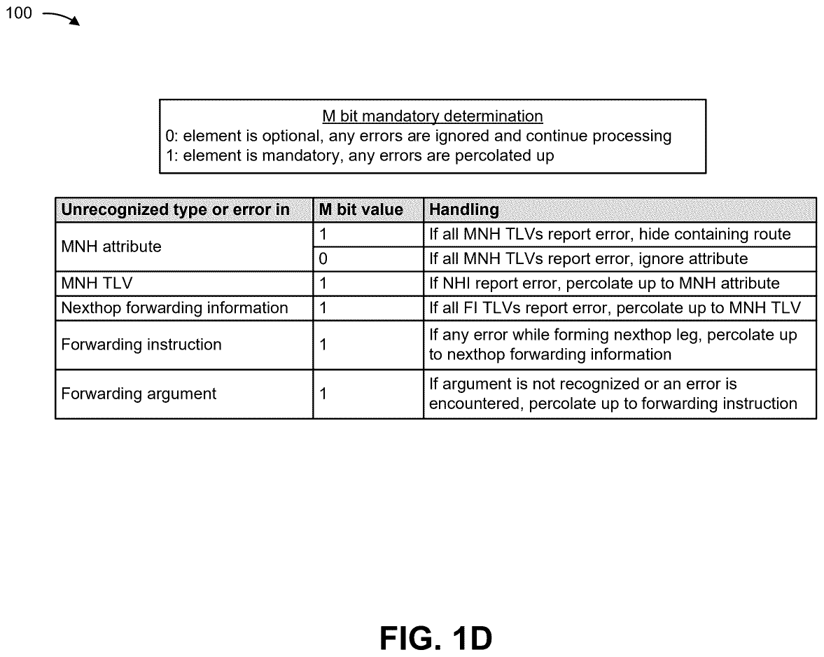

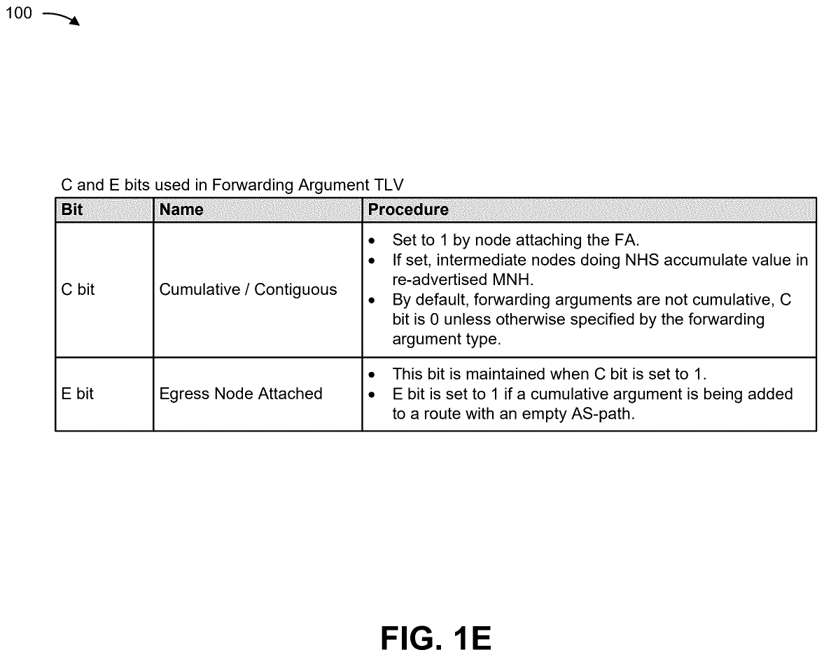

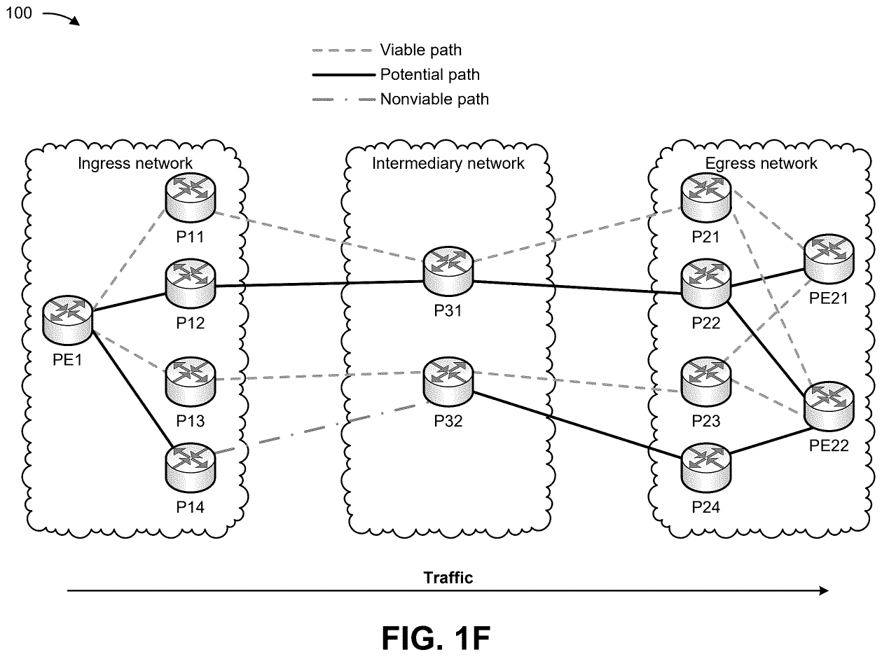

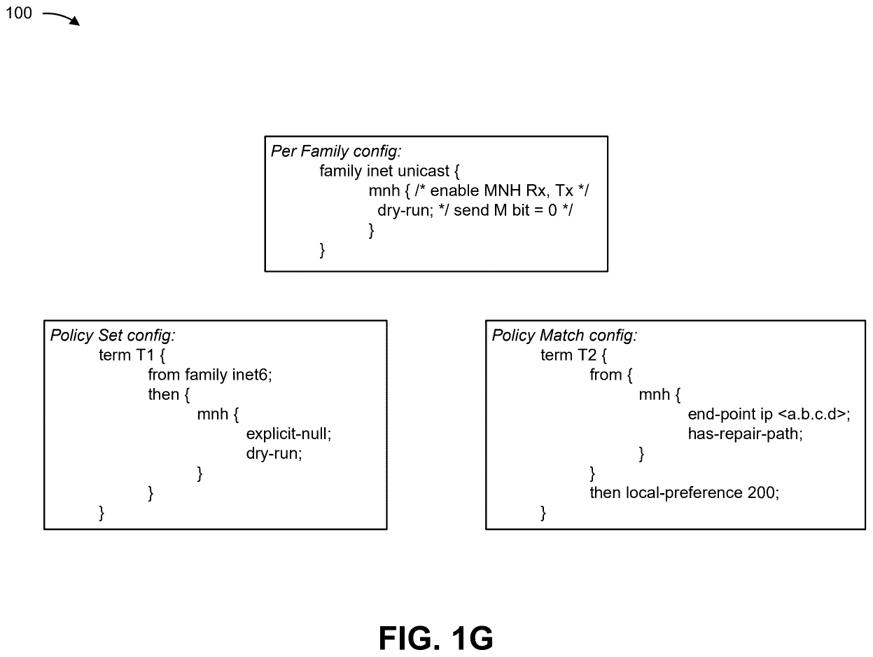

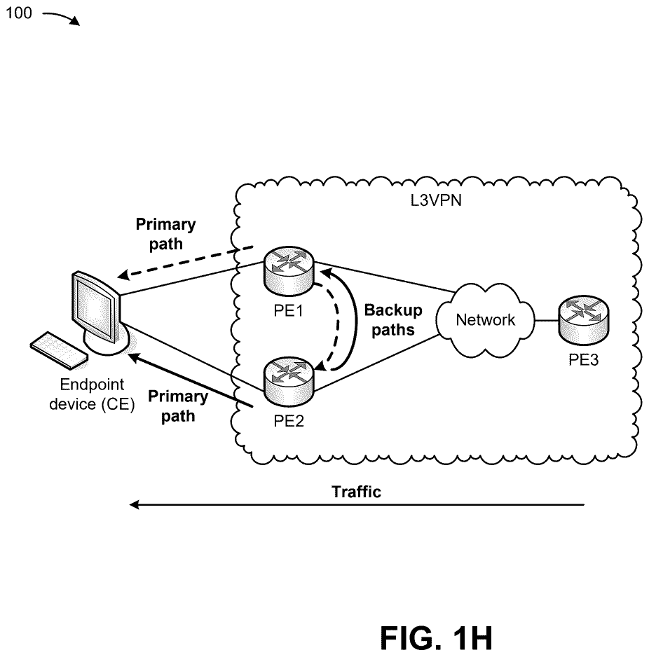

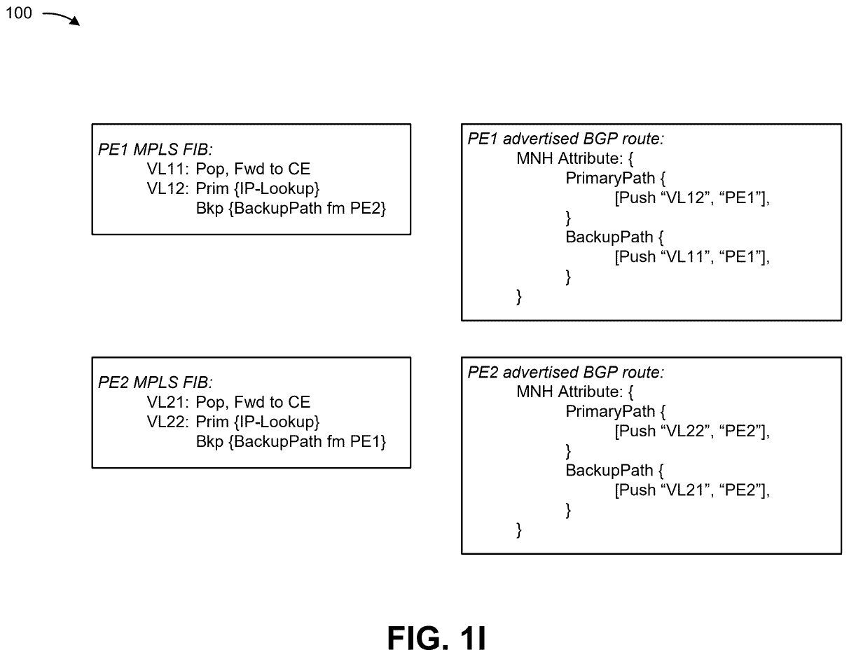

FIGS. 1A-1I are diagrams of an example 100 associated with error handling and continuity detecting for a BGP MultiNexthop attribute. As shown in FIGS. 1A-1I, the example 100 includes an endpoint device associated with an ingress network, an egress network, and a server device. The ingress network may include multiple network devices, such as provider (P)

network devices and a provider edge (PE) network device. The egress network may include multiple network devices, such as provider network devices and a provider edge network device. Further details of the endpoint device, the server device, the ingress network, the egress network, and the network devices are provided elsewhere herein. Although implementations are described in connection with a single network device, the implementations may be utilized by any number of network devices.

As further shown in FIG. 1A, and by reference number 105, a network device (e.g., the provider edge network device (PE1) of the ingress network) may receive a route from the endpoint device. For example, the endpoint device may generate a route for a destination (e.g., the server device), and may provide the route to the PE network device of the ingress network. The PE network device may receive the route from the endpoint device. In some implementations, the server device may generate a route for a destination (e.g., the endpoint device), and may provide the route to the PE network device of the egress network. The PE network device may receive the route from the server device.

As further shown in FIG. 1A, and by reference number 110, the network device may provide hierarchical error handling functionality in a BGP MNH attribute associated with the route. For example, the network device may enhance the BGP MNH attribute by providing hierarchical error handling in the BGP MNH attribute. In some implementations, the network device may provide a new bit (e.g., an “M” bit) in MNH TLV flags of the BGP MNH attribute. If the M bit is zero, the network device may ignore any error. If the M bit is one, the network device may percolate any error to an upper layer TLV, until the error reaches the MNH attribute.

As further shown in FIG. 1A, and by reference number 115, the network device may provide continuity detection functionality in the BGP MNH attribute. For example, the network device may enhance the BGP MNH attribute by providing continuity detection in the BGP MNH attribute. The network device may provide two new bits (e.g., a “C” bit and an “E” bit) to enable continuity detection in the BGP MNH attribute. The C bit (e.g., a cumulative or contiguous bit) may be set to one (1) by the network device attaching a forwarding argument. If the C bit is set to one, intermediate network devices performing a next hop service (NHS) may accumulate a value in a re-advertised MNH attribute. By default, the forwarding arguments are not cumulative and the C bit may be set to zero unless otherwise specified by a forwarding argument type. The E bit (e.g., an egress node attached bit) may be maintained when the C bit is set to one. The E bit may be set to one if a cumulative forwarding argument is added to a route with an empty autonomous systems (AS) path. Some forwarding arguments carried in the MNH attribute may need to accumulate a value across BGP next hop-self hops, and the network device may need to determine whether a forwarding argument signifies continuity until egress network devices are reached.

As further shown in FIG. 1A, and by reference number 120, the network device may provide the route to a destination based on the hierarchical error handling functionality, the continuity detection functionality, and the BGP MNH attribute. For example, the route may be routed through the ingress network and the egress network until the route is provided to the destination (e.g., the server device). A path of the route and provision of the route may be determined based on the hierarchical error handling functionality, the continuity detection functionality, and the BGP MNH attribute.

FIG. 1B depicts example syntax of a BGP MNH attribute. As shown, the BGP MNH attribute may include data identifying a primary path and a repair path for a route. Each of the primary path and the repair path may include multiple forwarding instructions (e.g., forwarding instructions 1 through n). As further shown, each forwarding instruction may include a forwarding action (FwdAction) and forwarding arguments (FwdArguments). In the context of BGP, a forwarding action and forwarding arguments may determine how the route should be handled and routed through a network. A forwarding action may include an instruction or command that dictates what should be done with the route (e.g., drop the route, forward the route to a next hop in a path to a destination, redirect the route to another network device or a different path, encapsulate the route in another protocol layer, or modify the route). Forwarding arguments may complement a forwarding action by providing additional parameters or details needed to execute the forwarding action. The forwarding arguments may specify how the forwarding action should be implemented, allowing precise control over route management. Examples of forwarding arguments may include a next hop address, a label stack to be applied to the route for routing in a network, a class to be applied to the route, security parameters, tunnel endpoint information, bandwidth, constraints, and/or the like.

FIG. 1C depicts an example unified modeling language (UML) view of the BGP MNH attribute. As shown, the BGP MNH attribute may include an MNH header and TLVs. The MNH header may include a version number (e.g., zero), flags (e.g., a bit, such as an M bit), and an advertisement primary next hop (PNH) that indicates a primary path that a route should take to reach a destination. The MNH TLVs may include flags (e.g., a bit, such as an M bit), a number of next hops (NmNH), and next hop forwarding information (NFI). The next hop forwarding information may include flags (e.g., a bit, such as an M bit), a number of next hops (NmNH), and forwarding instructions (FIs). As further shown, the MNH TLVs may be associated with a primary path and a repair path (e.g., a backup path for a route).

As further shown in FIG. 1C, a forwarding instruction may include flags (e.g., a bit, such as an M bit), a relative preference, a forwarding action, and forwarding arguments. The forwarding action may include, for example, a forwarding action for the route or a push action for the route. A forwarding argument may include flags (e.g., bits, such as an E bit, a C bit, and an M bit), a type, and a length (Len). The forwarding argument may be associated with an endpoint identifier (e.g., where to forward route), constraints (e.g., a proximity check and a color of path to use), encapsulation information (e.g., a label stack, an SID, and/or the like), and endpoint attributes (e.g., a bandwidth and AIGP).

FIG. 1D depicts an example of the hierarchical error handling functionality provided in the BGP MNH attribute. As shown, the M bit may be utilized to provide the hierarchical error handling functionality. For example, if the M bit is zero (0) (e.g., optional), the network device may ignore any errors and continue processing the route. Alternatively, if the M bit is one (1) (e.g., mandatory), the network device may percolate up any errors. If there is an unrecognized type or error in the MNH attribute and the M bit is one, the network device may hide a containing route if all MNH TLVs report an error. If there is an unrecognized type or error in the MNH attribute and the M bit is zero, the network device may ignore the MNH attribute if all MNH TLVs report an error.

As further shown in FIG. 1D, if there is an unrecognized type or error in an MNH TLV and the M bit is one, the network device may percolate a next hop information (NHI) reported error up to the MNH attribute. If there is an unrecognized type or error in next hop forwarding information and the M bit is one, the network device may percolate all forwarding information (FI) TLV reported errors up to the MNH TLV. If there is an unrecognized type or error in a forwarding instruction and the M bit is one, the network device may percolate any error generated while forming a next hop leg up to the next hop forwarding information. If there is an unrecognized type or error in a forwarding argument and the M bit is one, the network device may percolate an error encountered in the forwarding argument (or if the forwarding argument is not recognized) up to the forwarding instruction.

FIG. 1E depicts an example of the continuity detection functionality provided in the BGP MNH attribute. As shown, the C bit (e.g., a cumulative or contiguous bit) may be set to one (1) by a network device attaching a forwarding argument. If the C bit is set to one, intermediate network devices performing a next hop service (NHS) may accumulate a value in a re-advertised MNH attribute. By default, the forwarding arguments are not cumulative and the C bit may be set to zero unless otherwise specified by a forwarding argument type. As further shown in FIG. 1E, the E bit (e.g., an egress node attached bit) may be maintained when the Cbit is set to one. The E bit may be set to one if a cumulative forwarding argument is added to a route with an empty autonomous systems (AS) path.

In some implementations, a forwarding argument of type “accumulated metric” may set the C bit to one and the E bit may enable determining whether the accumulated metric was attached at an egress network device. The accumulated metric forwarding argument may enable a subset of an interior gateway protocol (IGP) metric type registry that includes an IGP cost and a link delay and does not include a traffic engineering (TE) metric and a bandwidth. In some implementations, any forwarding argument that needs continuity detection may utilize the continuity detection functionality. For example, a forwarding argument of type “EP bandwidth” may utilize the C and E bits in order to differentiate between whether a bandwidth is up to an egress network device or an intermediate hop network device. In another example, a forwarding argument of type “path constraints” may utilize the C bit to hold a proximity/transport-class constraint throughout a route readvertisement path.

FIG. 1F depicts an example of utilizing the continuity detection functionality for an accumulated metric provided in the BGP MNH attribute. As shown, an ingress network may include a PE network device (e.g., PE1) and four provider network devices (e.g., P11, P12, P13, and P14). An egress network may include two PE network devices (e.g., PE21 and PE22) and four provider network devices (e.g., P21, P22, P23, and P24). An intermediary network may include two provider network devices (e.g., P31 and P32). The network devices may be interconnected by viable paths (e.g., shown in dashed lines), potential paths (e.g., shown in solid lines), and nonviable paths (e.g., shown in dash-dotted lines). A subsequent address family identifier (SAFI) route for PE21 and PE32 may originate at PE21 or P21. A SAFI route for PE22 and PE32 may originate at PE32 or P21.

An MNH accumulated metric, if added at P11 or P31, may not include a set E bit since an AS path is not empty. An MNH accumulated metric, if added at PE21 or P21, may include a set E bit since an AS path is empty. P22 and P24 may be pruned from a path for the route since P22 and P24 do not understand MNH or an MNH accumulated metric (e.g., unknown forwarding arguments are not propagated by P22 and P24). An MNH attribute received at PE1 via P14 may not have the accumulated metric since P12 cannot determine latency to P32. An MNH accumulated metric, added at PE21 and received at PE1 (e.g., via P11, P31, and P21 and via P13, P32, and P23) may have both the E bit and the C bit set. In this way, PE1 discovers two paths to PE21 with known end-to-end latency.

FIG. 1G depicts example syntax associated with an MNH configuration model. As shown, the MNH configuration model may include a per family configuration that defines a family configuration for MNH (e.g., enable MNH receipt and transmission, set M bit=0). The MNH configuration model may include a policy set configuration that defines terms for MNH (e.g., term T1). The MNH configuration model may include a policy match configuration that defines terms for MNH (e.g., term T2).

FIG. 1H depicts an example use case for the MNH attribute to avoid a forward loop between multihomed provider edge network devices. As shown, a Layer 3 virtual private network (L3VPN) may include three provider edge network devices (e.g., PE1, PE2, and PE3), where PE1 and PE2 are interconnected with PE3 via a network. As further shown, PE1 and PE2 may connect with the endpoint device (e.g., a customer edge (CE) device). PE1 may provide a primary path (e.g., shown in a dashed line) for a route directly to the endpoint device, and may provide a backup path (e.g., shown in a dashed line), via PE2, for a route to the endpoint device. PE2 may provide a primary path (e.g., shown in a solid line) for a route directly to the endpoint device, and may provide a backup path (e.g., shown in a solid line), via PE1, for a route to the endpoint device.

FIG. 1I depicts example syntax associated with the example use case of FIG. 1H. As shown, a multiprotocol label switching (MPLS) forwarding information base (FIB) of PE1 may include a first label (VL11) that defines pop and forwarding a route to the endpoint device (CE), and a second label (VL12) that defines a primary path (e.g., via an IP lookup) and a backup path (e.g., from PE2). As further shown, an MPLS FIB of PE2 may include a first label (VL21) that defines forwarding to the endpoint device (CE), and a second label (VL22) that defines a primary path (e.g., via an IP lookup) and a backup path (e.g., from PE1). An advertised BGP route from PE1 may include an MNH attribute with the primary path (e.g., push VL12) and the backup path (e.g., push VL11). An advertised BGP route from PE2 may include an MNH attribute with the primary path (e.g., push VL22) and the backup path (e.g., push VL21).

In this way, the network device provides error handling and continuity detecting for a BGP MultiNexthop attribute. For example, the network device may enhance a BGP MNH attribute by providing hierarchical error handling in the BGP MNH attribute. The network device may provide a new bit in MNH TLV flags of the BGP MNH attribute. If the bit is zero, the network device may ignore any error. If the bit is one, the network device may percolate any error to an upper layer TLV, until the error reaches the MNH attribute. The network device may also provide continuity detection in the BGP MNH attribute. The network device may provide two new bits to enable continuity detection in the BGP MNH attribute. Thus, the network device conserves computing resources, networking resources, and/or the like that would otherwise have been consumed by failing to advertise more than one next hop in a route, failing to extend expressing next hops to newer endpoint types and/or encapsulation types, failing to express a relationship between different next hops, failing to signal encapsulation information uniformly across families, failing to signal an additional label stack for a repair path in a route, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

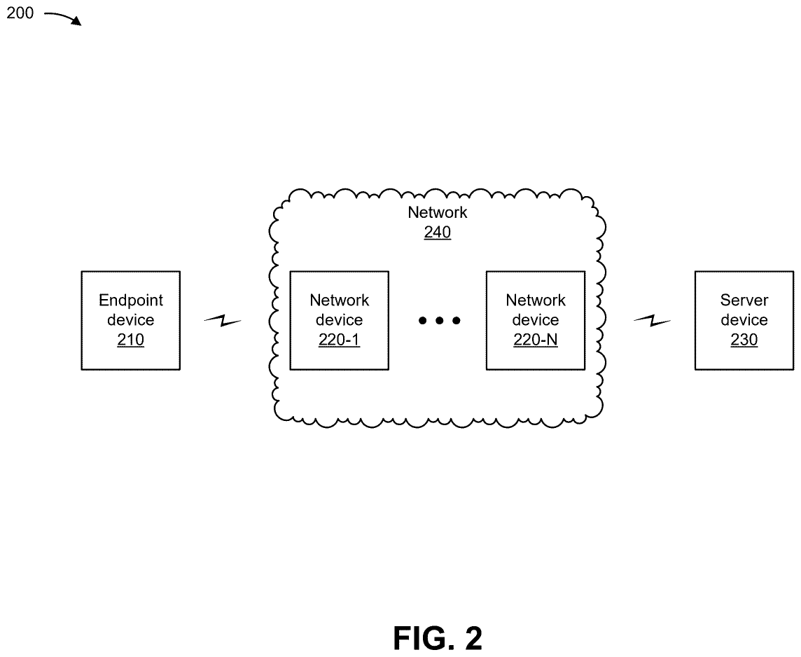

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a WAN, a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

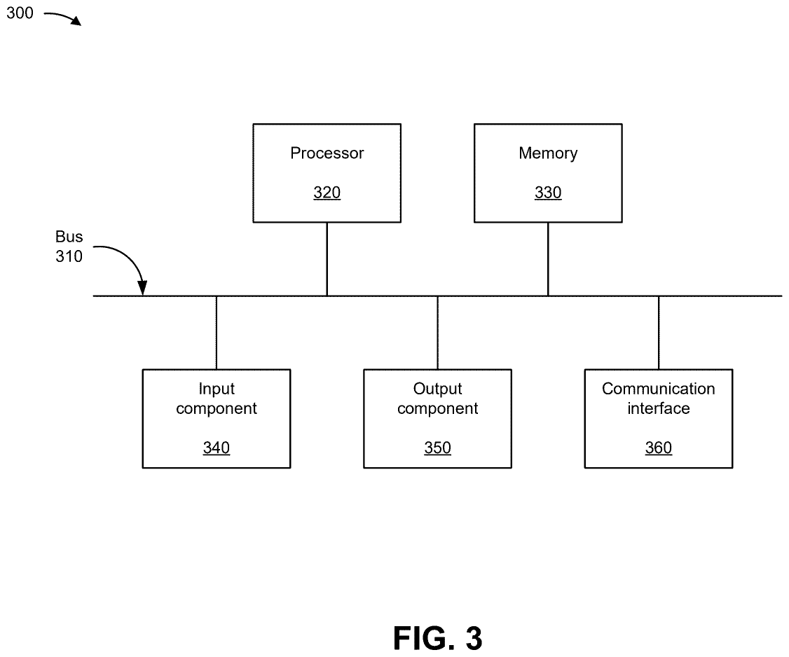

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

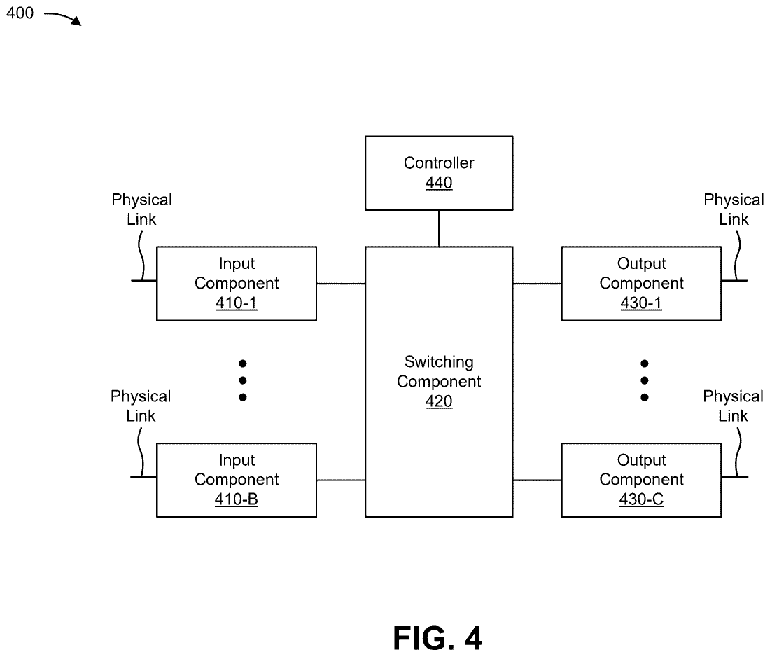

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

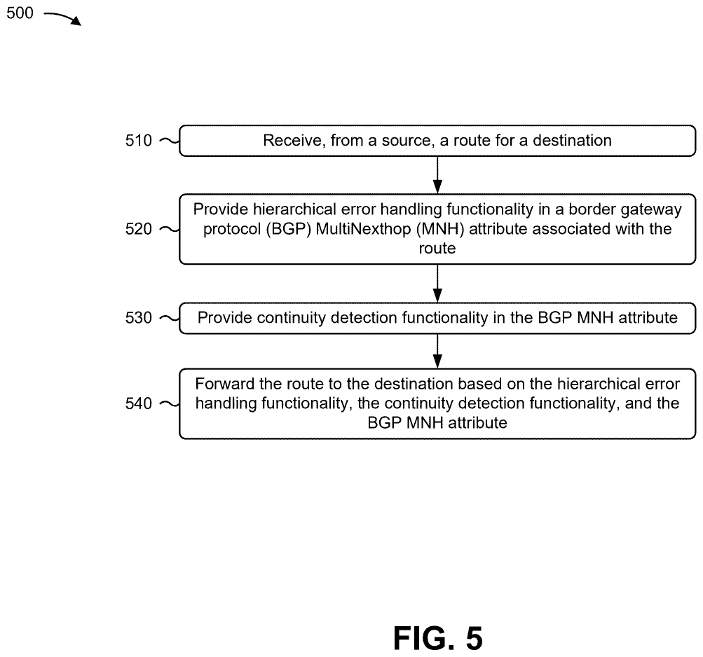

FIG. 5 is a flowchart of an example process 500 for error handling and continuity detecting for a BGP multiple next hop attribute. In some implementations, one or more process blocks of FIG. 5 may be performed by a network device (e.g., the network device 220). In some implementations, one or more process blocks of FIG. 5 may be performed by another device or a group of devices separate from or including the network device, such as an endpoint device (e.g., the endpoint device 210) and/or a server device (e.g., the server device 230). Additionally, or alternatively, one or more process blocks of FIG. 5 may be performed by one or more components of the device 300, such as the processor 320, the memory 330, the input component 340, the output component 350, and/or the communication component 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving, from a source, a route for a destination (block 510). For example, the network device may receive, from a source, a route for a destination, as described above. In some implementations, the source is an endpoint device and the network device is a provider edge network device associated with an ingress network. In some implementations, the source is a server device and the network device is a provider edge network device associated with an egress network.

As further shown in FIG. 5, process 500 may include providing hierarchical error handling functionality in a BGP MNH attribute associated with the route (block 520). For example, the network device may provide hierarchical error handling functionality in a BGP MNH attribute associated with the route, as described above. In some implementations, providing the hierarchical error handling functionality in the BGP MNH attribute includes providing a bit in MNH type-length-value (TLV) flags of the BGP MNH attribute to provide the hierarchical error handling functionality. In some implementations, process 500 includes setting the bit to zero to cause any error to be ignored. In some implementations, process 500 includes setting the bit to one to percolate any error to an upper layer TLV until the error reaches the BGP MNH attribute.

In some implementations, the BGP MNH attribute includes an MNH header and an MNH type-length-value, the MNH header includes a version number, flags, and an advertisement primary next hop that indicates a primary path that the route is to take to reach the destination, and the MNH TLV includes flags, a number of next hops, and next hop forwarding information.

As further shown in FIG. 5, process 500 may include providing continuity detection functionality in the BGP MNH attribute (block 530). For example, the network device may provide continuity detection functionality in the BGP MNH attribute, as described above. In some implementations, providing the continuity detection functionality in the BGP MNH attribute includes providing a cumulative bit and an egress node attached bit in the BGP MNH attribute to enable the continuity detection functionality. In some implementations, process 500 includes one of setting the cumulative bit to one to cause intermediate network devices performing a next hop service to accumulate a value in a re-advertised BGP MNH attribute, or setting the cumulative bit to zero to prevent the intermediate network devices from accumulating the value in the re-advertised BGP MNH attribute. In some implementations, process 500 includes maintaining the egress node attached bit based on setting the cumulative bit to one. In some implementations, process 500 includes setting the egress node attached bit to one to add a cumulative forwarding argument to a route with an empty autonomous systems path.

As further shown in FIG. 5, process 500 may include forwarding the route to the destination based on the hierarchical error handling functionality, the continuity detection functionality, and the BGP MNH attribute (block 540). For example, the network device may forward the route to the destination based on the hierarchical error handling functionality, the continuity detection functionality, and the BGP MNH attribute, as described above.

In some implementations, process 500 includes utilizing the continuity detection functionality for an MNH accumulated metric provided in the BGP MNH attribute. In some implementations, process 500 includes utilizing the BGP MNH attribute to avoid a forward loop between the network device and another network device that is multihomed with the network device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device and from a source, a route for a destination;
providing, by the network device, hierarchical error handling functionality in a border gateway protocol (BGP) MultiNexthop (MNH) attribute associated with the route;
providing, by the network device, continuity detection functionality in the BGP MNH attribute; and
forwarding, by the network device, the route to the destination based on the hierarchical error handling functionality, the continuity detection functionality, and the BGP MNH attribute.

2. The method of claim 1, wherein the source of the route is an endpoint device and the network device is a provider edge network device associated with an ingress network.

3. The method of claim 1, wherein the source is a server device and the network device is a provider edge network device associated with an egress network.

4. The method of claim 1, wherein providing the hierarchical error handling functionality in the BGP MNH attribute comprises:
providing a bit in MNH type-length-value (TLV) flags of the BGP MNH attribute to provide the hierarchical error handling functionality.

5. The method of claim 4, further comprising:
setting the bit to zero to cause any error to be ignored.

6. The method of claim 4, further comprising:
setting the bit to one to percolate any error to an upper layer TLV until the error reaches the BGP MNH attribute.

7. The method of claim 1, wherein the BGP MNH attribute includes an MNH header and an MNH type-length-value,
wherein the MNH header includes a version number, flags, and an advertisement primary next hop that indicates a primary path that the route is to take to reach the destination, and
wherein the MNH TLV includes flags, a number of next hops, and next hop forwarding information.

8. A network device, comprising:
one or more memories; and
one or more processors to:
receive, from a source, a route for a destination;
provide hierarchical error handling functionality in a border gateway protocol (BGP) MultiNexthop (MNH) attribute associated with the route,
wherein the BGP MNH attribute includes an MNH header and an MNH type-length-value;
provide continuity detection functionality in the BGP MNH attribute; and
forward the route to the destination based on the hierarchical error handling functionality, the continuity detection functionality, and the BGP MNH attribute.

9. The network device of claim 8, wherein the one or more processors, to provide the continuity detection functionality in the BGP MNH attribute, are to:
provide a cumulative bit and an egress node attached bit in the BGP MNH attribute to enable the continuity detection functionality.

10. The network device of claim 9, wherein the one or more processors are further to one of:
set the cumulative bit to one to cause intermediate network devices performing a next hop service to accumulate a value in a re-advertised BGP MNH attribute; or
set the cumulative bit to zero to prevent the intermediate network devices from accumulating the value in the re-advertised BGP MNH attribute.

11. The network device of claim 10, wherein the one or more processors are further to:
maintain the egress node attached bit based on setting the cumulative bit to one.

12. The network device of claim 9, wherein the one or more processors are further to:
set the egress node attached bit to one to add a cumulative forwarding argument to a route with an empty autonomous systems path.

13. The network device of claim 8, wherein the one or more processors are further to:
utilize the continuity detection functionality for an MNH accumulated metric provided in the BGP MNH attribute.

14. The network device of claim 8, wherein the one or more processors are further to:
utilize the BGP MNH attribute to avoid a forward loop between the network device and another network device that is multihomed with the network device.

15. A non-transitory computer-readable medium storing a set of instructions, the set of instructions comprising:
one or more instructions that, when executed by one or more processors of a network device, cause the network device to:
receive, from a source, a route for a destination,
wherein the source of the route is one of an endpoint device or a server device;
provide hierarchical error handling functionality in a border gateway protocol (BGP) MultiNexthop (MNH) attribute associated with the route;
provide continuity detection functionality in the BGP MNH attribute; and
forward the route to the destination based on the hierarchical error handling functionality, the continuity detection functionality, and the BGP MNH attribute.

16. The non-transitory computer-readable medium of claim 15, wherein the one or more instructions, that cause the network device to provide the hierarchical error handling functionality in the BGP MNH attribute, cause the network device to: provide a bit in MNH type-length-value (TLV) flags of the BGP MNH attribute to provide the hierarchical error handling functionality.

17. The non-transitory computer-readable medium of claim 16, wherein the one or more instructions further cause the network device to one of:
set the bit to zero to cause any error to be ignored; or
set the bit to one to percolate any error to an upper layer TLV until the error reaches the BGP MNH attribute.

18. The non-transitory computer-readable medium of claim 15, wherein the one or more instructions, that cause the network device to provide the continuity detection functionality in the BGP MNH attribute, cause the network device to:
provide a cumulative bit and an egress node attached bit in the BGP MNH attribute to enable the continuity detection functionality.

19. The non-transitory computer-readable medium of claim 18, wherein the one or more instructions further cause the network device to one of:
set the cumulative bit to one to cause intermediate network devices performing a next hop service to accumulate a value in a re-advertised BGP MNH attribute; or
set the cumulative bit to zero to prevent the intermediate network devices from accumulating the value in the re-advertised BGP MNH attribute.

20. The non-transitory computer-readable medium of claim 18, wherein the one or more instructions further cause the network device to:
set the egress node attached bit to one to add a cumulative forwarding argument to a route with an empty autonomous systems path.
